(19) United States
(12) Patent Application Publication
(10) Pub. No.: US 2014/0165209 A1
(43) Pub. Date: Jun. 12, 2014

(54) DIGITAL CONTENT DELIVERY PLATFORM FOR MULTIPLE RETAILERS

(71) Applicant: VERIZON PATENT AND LICENSING INC., Basking Ridge, NJ (US)

(72) Inventor: Fenglin Yin, Lexington, MA (US)

(73) Assignee: VERIZON PATENT AND LICENSING INC., Basking Ridge, NJ (US)

(21) Appl. No.: 13/711,197

(22) Filed: Dec. 11, 2012

(51) Int. Cl. G06F 21/10

(52) U.S. Cl. CPC G06F 21/10; H04L 63/10
USPC 726/26

(57) ABSTRACT

A digital content distribution platform includes a content distribution device configured to store digital assets and associated metadata, encode and encrypt each of the digital assets, and publish the metadata associated with the assets to one or more catalog servers associated with multiple digital content retailers. The digital content distribution platform further includes a portal server configured to permit registration by the multiple digital content retailers to enable access to the stored digital assets by clients associated with the multiple digital content retailers. The digital content distribution platform also includes one or more license servers configured to engage in digital rights management (DRM) with multiple DRM servers associated with the multiple digital content retailers.

### BACKGROUND

Content delivery networks (CDNs) are interconnected systems of servers that can rapidly and cost effectively deliver a variety of digital content to numerous end points, such as web browsers, mobile devices, set-top boxes and gaming consoles, via the Internet. CDNs include large distributed systems of servers located in multiple data centers in the Internet. CDN nodes are typically deployed in multiple different locations, often across multiple different backbones. The number of nodes and servers of a CDN varies, depending on the CDN's architecture. CDNs serve a substantial portion of content on the Internet, including text, graphics, Uniform Resource Locators (URLs), scripts, media files, software, documents, applications, social networks, and streaming media.

For serving content via streaming media, CDNs may, for example, use Hypertext Transfer Protocol (HTTP) Live Streaming (HLS). HLS is a HTTP-based media streaming communications protocol that involves breaking the media stream into a sequence of file downloads. Each file may be downloaded as one portion of a transport stream. Each downloaded file may be played in sequence to present a continuous media stream. As a given stream is played, the client may choose from multiple different alternative streams containing the same content encoded at various data rates. At the beginning of a streaming session, the client downloads a playlist file that specifies the different or alternate streams that are available.

In HLS, a given multimedia presentation is specified by a Uniform Resource Identifier (URI) to the playlist file, which itself includes an ordered list of media URIs and informational tags. Each media URI refers to a media file that is a segment of a single continuous media stream. To play a stream, a client first obtains the playlist file and then obtains and plays each media file in the playlist in sequence.

### BRIEF DESCRIPTION OF THE DRAWINGS

FIG. 1 is a diagram that illustrates an overview of an exemplary implementation of a digital content delivery platform for delivering digital content to multiple different digital content retailers;

FIG. 2A is a diagram that depicts an exemplary network environment in which the digital content delivery platform of FIG. 1 delivers digital content to multiple different digital content retailers;

FIG. 2B is a diagram that depicts further details of digital content delivery via the various nodes of the content delivery network of FIG. 2A;

FIG. 3 depicts an exemplary network environment associated with a retailer of FIG. 1;

FIG. 4 is a diagram that depicts exemplary components of a network device;

FIG. 5 is a diagram that depicts functional components of the content distribution device of FIG. 1 according to an exemplary embodiment;

FIG. 6 is a flow diagram of an exemplary process for retailer registration and retailer certificate generation to enable clients of the retailers to access assets stored at the digital content distribution platform of FIG. 1;

FIG. 7 is an exemplary messaging diagram associated with the exemplary process of FIG. 6;

FIG. 8 is a flow diagram of an exemplary process for digital rights management registration of a client of a retailer of FIG. 1;

FIG. 9 is an exemplary messaging diagram associated with the exemplary process of FIG. 8;

FIGS. 10A-10C are flow diagrams of an exemplary process for digital rights management license acquisition and asset streaming or download to clients of the retailers of FIG. 1; and

FIG. 11 is an exemplary messaging diagram associated with the exemplary process of FIGS. 10A-10C.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

Exemplary embodiments described herein implement a digital content distribution platform that provides digital content processing, digital content delivery, and digital rights management to multiple different digital content retailers. Each of the multiple different digital content retailers subscribes to digital content distribution services offered by the digital content distribution platform to enable each of the retailer's customers to access digital content stored at the digital content distribution platform. The digital content distribution platform manages digital content acquisition, content transcoding and encryption, content delivery services, and digital rights management. Each of the multiple different digital content retailers manage services to individual customers, such as customer authentication, customer account management, customer content rental or purchasing, and customer billing for access to digital content stored at the digital content distribution platform. As described herein, the digital content retailers interact with the digital content distribution platform to enable the platform to deliver customer-selected digital content to the customers at client devices.

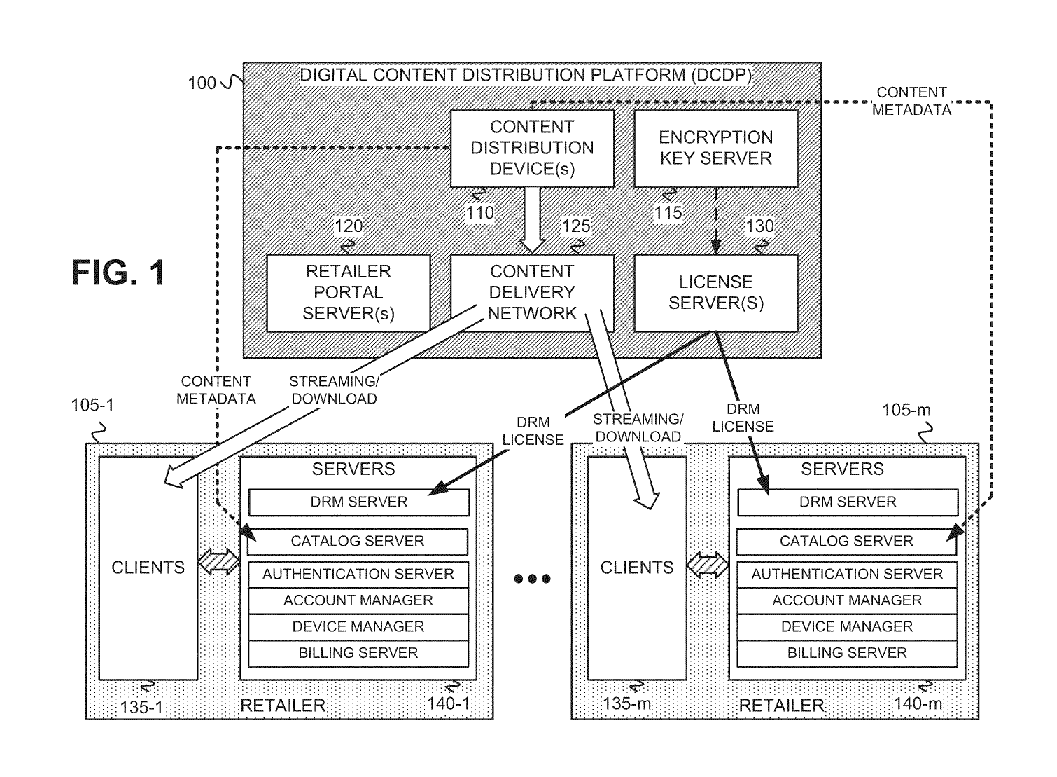

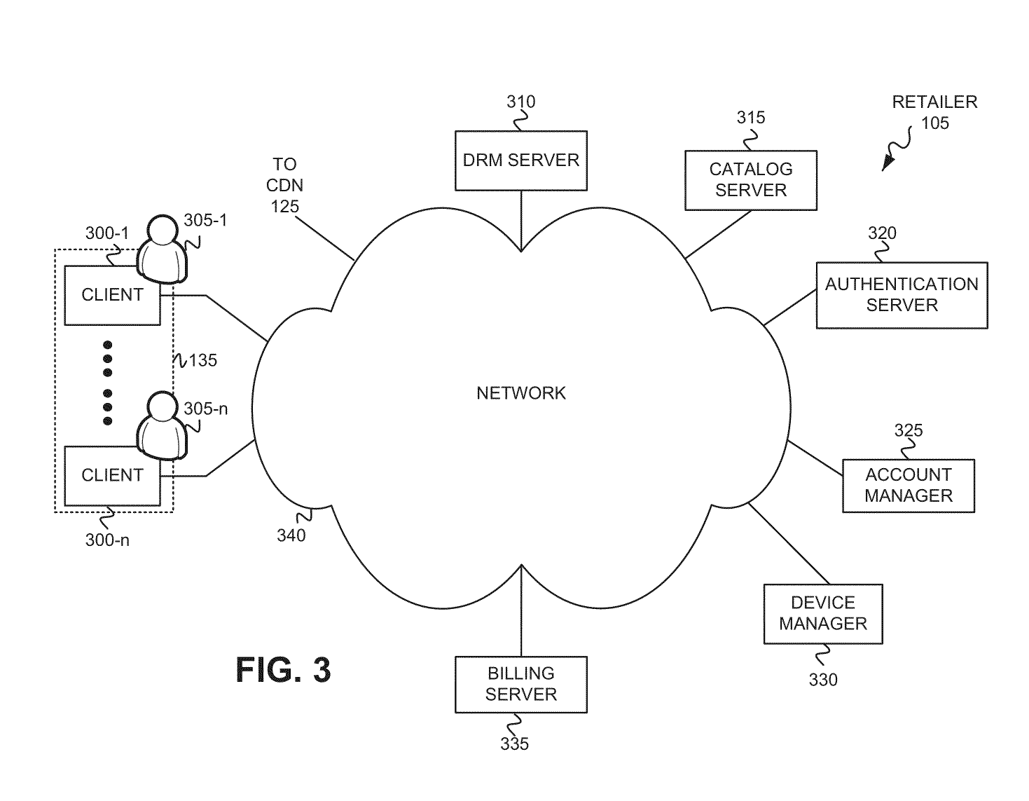

FIG. 1 illustrates an overview of an exemplary implementation of a digital content delivery platform for delivering digital content to multiple different digital content retailers. As shown in FIG. 1, a digital content delivery platform (DCDP) 100, that encodes, encrypts and stores digital assets, may stream, or permit the download of, those assets to multiple different retailers 105-1 through 105-m (generically referred to herein as a “retailer 105”). An “asset,” as referred to herein, includes a unit of digital content that may be provided by DCDP 100 to a requesting client of a retailer. The unit of digital content may include, for example, a segment of text, a defined set of graphics, a URL, a script, a program, an application or other unit of software, a media file (e.g., a movie, television content, music, etc.), a document, or an interconnected sequence of files (e.g., HLS streaming media files). DCDP 100, as shown in FIG. 1, may include a content distribution device(s) 110, an encryption key server 115, a retailer portal server(s) 120, a content distribution network 125, and a license server(s) 130. As further shown in FIG. 1, retailer 105-1 may include clients 135-1 (generically referred to herein as “clients 135”) and multiple servers 140-1 (generically referred to herein as “servers 140”), and retailer 105-m may include clients 135-m and multiple servers 140-m. Multiple servers 140-1 through 140-m may each include a Digital Rights Management (DRM) server, a catalog server, an authentication server, an account manager, a device manager, and a billing server. Each of the servers of multiple servers 140-1 through 140-m is described further below with respect to FIG. 3.

Content distribution device(s) 110 may encode each asset of multiple assets stored at DCDP 100 into different quality files, including multiple different bit rates and/or multiple different resolutions. For example, content distribution device(s) 110 may encode asset A at bit rates 1, 2 and 3, and may encode asset B at resolutions 1 and 2. Content distribution device(s) 110 may encrypt each encoded asset using encryption keys received from encryption key server 115. Content distribution device(s) 110 may further publish content metadata, associated with stored assets, to catalog servers at retailers 105-1 through 105-m. Encryption key server 115 may generate an encryption key for each asset stored by device(s) 110 and may supply the encryption keys to device(s) 110.

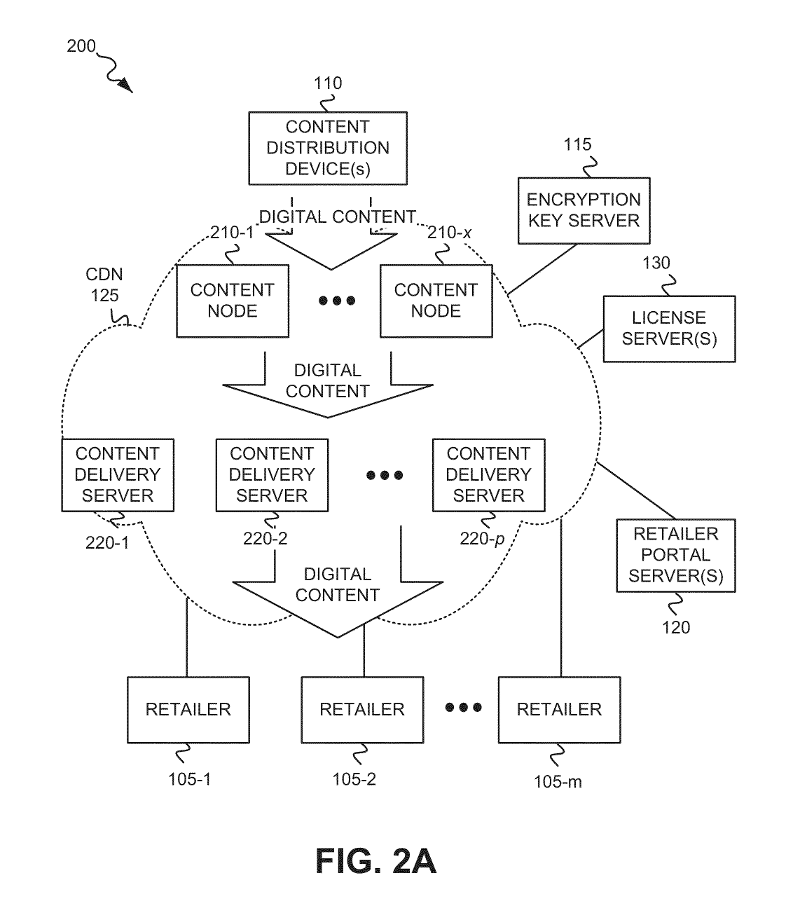

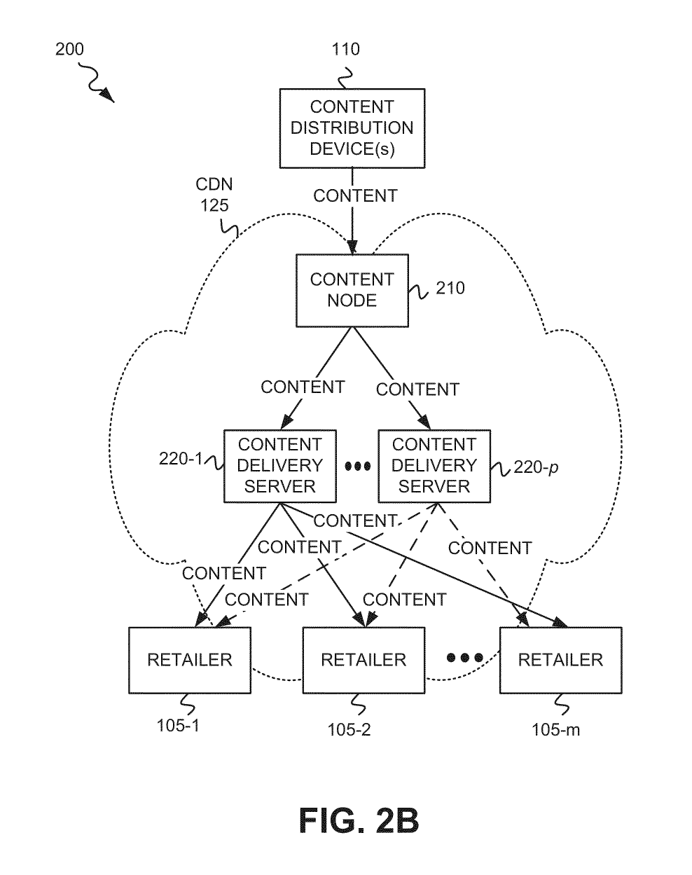

Retailer portal server(s) 120 may provide functionality for retailer 105 to register with DCDP 100, and to obtain digital certificates necessary to access assets stored at content distribution device(s) 110. Content delivery network (CDN) 125 may include a network having multiple nodes that allow the streaming of, or download of, digital content from content distribution device(s) 110 to clients 135 at retailers 105. CDN 125 is described further below with respect to FIGS. 2A and 2B. License server(s) 130 may provide functionality for clients 135 of retailers 105 to perform digital rights management (DRM) registrations via retailer DRM servers, and to generate DRM licenses for clients 135 of retailers 105.

Each client of clients 135 of retailer 105 may include any type of device that may receive digital content from DCDP 100 based on an account with a retailer 105. Each of clients 135 may include any type of computational device that can communicate with servers 140 and content distribution device(s) 100. Each of clients 135 may include, for example, a computer (e.g., desktop, laptop, palmtop or tablet computer), a Personal Digital Assistant (PDA), a cellular telephone (e.g., a smart phone), or a Set-Top Box (STB). The various servers of servers 140 of retailer 105 are described further below with respect to FIG. 3.

FIG. 2A depicts an exemplary network environment 200 in which the digital content delivery platform of FIG. 1 delivers digital content to multiple different digital content retailers. Network environment 200 may include content distribution device(s) 110, encryption key server 115, retailer portal server(s) 120, license server(s) 130, content delivery network 125 and retailers 105-1 through 105-m.

Content distribution device (s) 110 may deliver digital content (i.e., selected assets) via multiple nodes of content delivery network 125 to clients of retailers 105-1 through 105-m. As shown in FIG. 2A, content delivery network 125 may include content nodes 210-1 through 210-x (generically and individually referred to herein as “content node 210”) and content delivery servers 220-1 through 220-p (generically and individually referred to herein as “content delivery server 220”). Content nodes 210-1 through 210-x may include network nodes that distribute content to selected ones of content delivery servers 220-1 through 220-p based on routing decisions that route the digital content to requesting clients at retailers 105-1 through 105-m via content delivery servers 220-1 through 220-p. Content delivery servers 220-1 through 220-p may include network nodes that receive digital content delivered from content nodes 210-1 through 210-x, and deliver that digital content to content requesting clients at retailers 105-1 through 105-m.

Content delivery network 125 may include one or more networks including, for example, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., Public Switched Telephone Networks (PSTNs)), a local area network (LAN), a wide area network (WAN), a metropolitan area network (MAN), an intranet, the Internet, or a cable network (e.g., an optical cable network). Content delivery network 125 may enable content distribution device(s) 110, encryption key server 115, license server(s) 130, retailer portal server(s) 120, and retailers 105-1 through 105-m to communicate with one another, and to route/deliver digital content from one node to a next node (e.g., from content distribution device(s) 110 to content node 210, from content node 210 to content delivery server 220, from content delivery server 220 to a client at retailer 105).

The configuration of network components of network environment 200 shown in FIG. 2A is for illustrative purposes. Other configurations may be implemented. Therefore, network environment 200 may include additional, fewer and/or different components, that may be configured in a different arrangement, than that depicted in FIG. 2A.

FIG. 2B depicts further details of digital content delivery via the various nodes of content delivery network 125. As shown in FIG. 2B, content distribution device(s) 110 may deliver (e.g., publish) digital content to content node 210. Content node 210 may distribute the media to an appropriate content delivery server 220 via network 125. In turn, content delivery server 220 may distribute the digital content to a requesting client at a retailer 105 via network 125. For example, as depicted in FIG. 2B, content delivery server 220 may deliver the digital content to a requesting client at any of retailers 105-1 through 105-m, and content delivery server 220-p may deliver the digital content to a requesting client at any of retailers 105-1 through 105-m. The delivery of digital content from content node 210 to content delivery servers 220-1 through 220-p, and from content delivery servers 220-1 through 220-p to retailers 105-1 through 105-m may occur via one or more intervening nodes (not shown) of network 125, which may receive and forward data units associated with the delivered digital content.

FIG. 3 depicts an exemplary network environment associated with retailer 105. The network environment of retailer 105 may include clients 135, a DRM server 310, a catalog server 315, an authentication server 320, an account manager 325, a device manager 330, a billing server 335, and a network 340. As shown, network 340 may connect with CDN 125 of FIG. 2A. In other embodiments, CDN 125 may comprise a portion of network 340, or CDN 125 and network 340 may be the same network.

Clients 135 may include multiple clients 300-1 through 300-n, with each of clients 300-1 through 300-n being associated with a respective user 305-1 through 305-n.

DRM server 310 may obtain a DRM registration on behalf of clients 300-1 through 300-n and store a client DRM certificate generated by license server 130 for obtaining licenses on behalf of clients 300-1 through 300-n. DRM server 310 may further generate a CDN access token for ones of clients 300-1 through 300-n that are DRM registered. DRM server 310 may also receive and record playback status reports from clients 300-1 through 300-n.

Catalog server 315 may receive and store metadata associated with assets stored at DCDP 100 as a catalog of available content such that users 305-1 through 305-n associated with respective clients 300-1 through 300-n may browse the assets in the catalog for streaming or downloading of the assets from DCDP 100. Authentication server 320 may validate log-in credentials of users 305-1 through 305-n and establish a session for servers 140 for a respective retailer 105.

Account manager 325 may maintain account information associated with users 305-1 through 305-n, including log-in credentials used by authentication server 320 for validating log-ins of users 305-1 through 305-n. The account information may include, for example, contact names, email addresses, mailing addresses, billing information, authorized device information, entitlement rights of content, user preferences, and transaction history information that details assets viewed, rented and/or purchased for each of users 305-1 through 305-n. Account manager may manage services to users 305-1 through 305-n.

Device manager 330 may manage clients 300-1 through 300-n, including maintaining connectivity, and other, information for each of clients 300-1 through 300-n for a respective retailer 105. Billing server 335 may process rental and purchase transactions of assets from DCDP 100 by users 305-1 through 305-n. Network 340 may include any type of network, such as, for example, a local area network (LAN), a wide area network (WAN), a metropolitan area network (MAN), an intranet, or the Internet.

The configuration of network components of the network environment shown in FIG. 3 is for illustrative purposes. Other configurations may be implemented. Therefore, the network environment of FIG. 3 may include additional, fewer and/or different components that may be configured in a different arrangement than that depicted in FIG. 3.

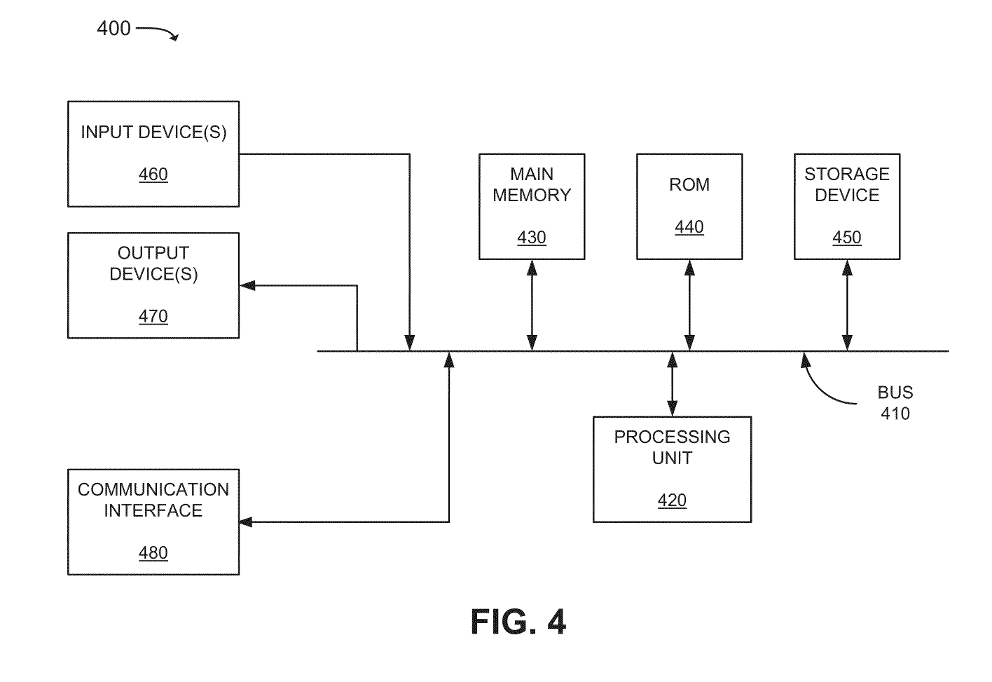

FIG. 4 is a diagram that depicts exemplary components of a network device 400. Network device 400 may correspond to content distribution device(s) 110, encryption key server 115, retailer portal server(s) 120, license server(s) 130, client 300, DRM server 310, catalog server 315, authentication server 320, account manager 325, device manager 330 and billing server 335. Network device 400 may include a bus 410, a processing unit 420, a main memory 430, a read only memory (ROM) 440, a storage device 450, an input device(s) 460, an output device(s) 470, and a communication interface(s) 480. Bus 410 may include a path that permits communication among the components of network device 400.

Processing unit 420 may include one or more processors or microprocessors, or processing logic, which may interpret and execute instructions. Main memory 430 may include a random access memory (RAM) or another type of dynamic storage device that may store information and instructions for execution by processing unit 420. ROM 440 may include a ROM device or another type of static storage device that may store static information and instructions for use by processing unit 420. Storage device 450 may include a magnetic and/or optical recording medium. Main memory 430, ROM 440 and storage device 450 may each be referred to herein as a “computer-readable medium.”

Input device 460 may include one or more mechanisms that permit an operator to input information to network device 400, such as, for example, a keypad or a keyboard, a display with a touch sensitive panel, voice recognition and/or biometric mechanisms, etc. Output device 470 may include one or more mechanisms that output information to the operator, including a display, a speaker, etc. Input device 460 and output device 470 may, in some implementations, be implemented as a user interface (UI) that displays UI information and which receives user input via the UI. Communication interface(s) 480 may include a transceiver that enables network device 400 to communicate with other devices and/or systems. For example, communication interface(s) 480 may include wired or wireless transceivers for communicating via content delivery network 125 or network 340.

The configuration of components of network device 400 illustrated in FIG. 4 is for illustrative purposes. Other configurations may be implemented. Therefore, network device 400 may include additional, fewer and/or different components than those depicted in FIG. 4.

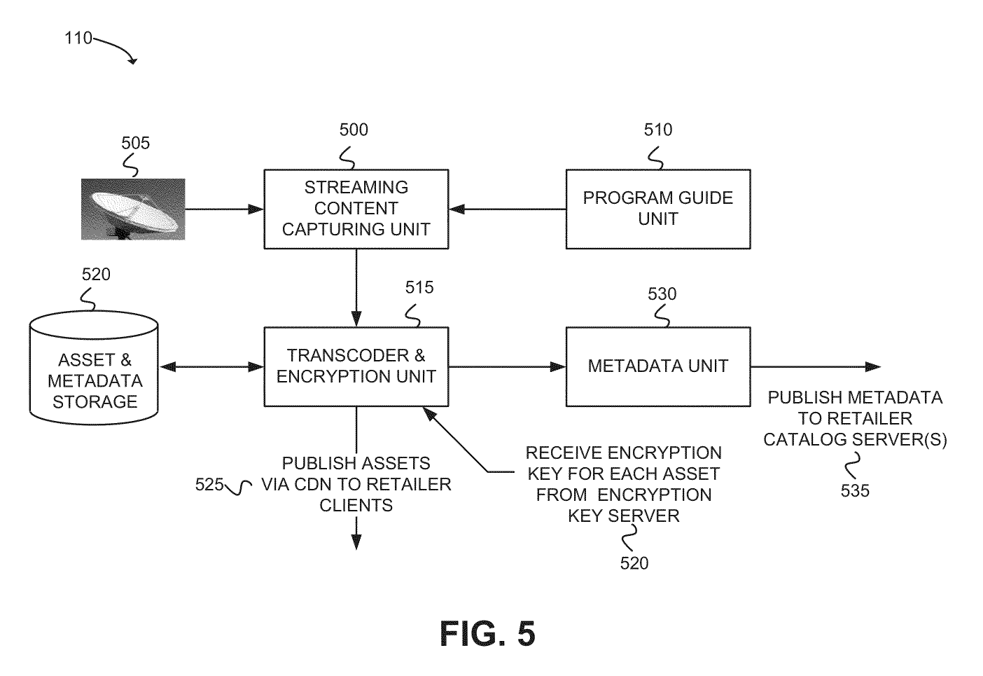

FIG. 5 depicts functional components of content distribution device 110 according to an exemplary embodiment. As shown, content distribution device 110 may include a streaming content capturing unit 500, a program guide unit 510, a transcoder and encryption unit 515, asset and metadata storage 520, and a metadata unit 530. In some implementations, the components of content distribution device 110 shown in FIG. 5 may be implemented as software and executed by processing unit 420. In other implementations, the components of content distribution device 110 shown in FIG. 5 may be implemented as hardware.

Streaming content capturing unit 500 may receive and capture content streams from live streaming sources 505. Unit 500 may receive and capture content streams on each channel over which live streaming sources 505 stream content. Unit 500 may tag captured content streams on each channel with a unique asset identifier (ID) that includes a channel number, a program ID, and an airing time. The channel number, program ID, and airing time may be obtained from program guide unit 510. Unit 500 may supply the captured and tagged content to transcoder and encryption unit 515.

Program guide unit 510 may obtain program metadata associated with each channel from which streaming content capturing unit 500 receives and captures content. Program guide unit 510 may obtain the program metadata from, for example, a program guide channel provided by sources 505. The program metadata may include, for example, a channel number, a program ID and an airing time associated with received content. The program metadata may include other data associated with the received content, including a description of the content, a first air date of the content, a type of the content (e.g., news, sports, situation comedy, drama, movie), etc. The program ID may include a title of the content and/or a title of the particular episode. The description of the content may generally describe what the content is about (e.g., the content of a story of the content, the content of a news program, etc.).

Transcoder and encryption unit 515 may encode each asset into different quality files (e.g., different bit rates and resolutions). Unit 515 may encrypt the encoded assets using encryption keys received 520 from encryption key server 115, and may store the encoded and encrypted assets in storage 520 for future retrieval. Transcoder and encryption unit may retrieve assets stored in storage 520, and publish 525 those assets to clients 135 at retailers 105.

Asset and metadata storage 520 may store encoded and encrypted assets received from transcoder and encryption unit 515, and program metadata received from program guide unit 510. Metadata unit 530 may publish 535 metadata associated with the assets stored in storage 520 to catalog servers of retailer 105-1 through 105-m.

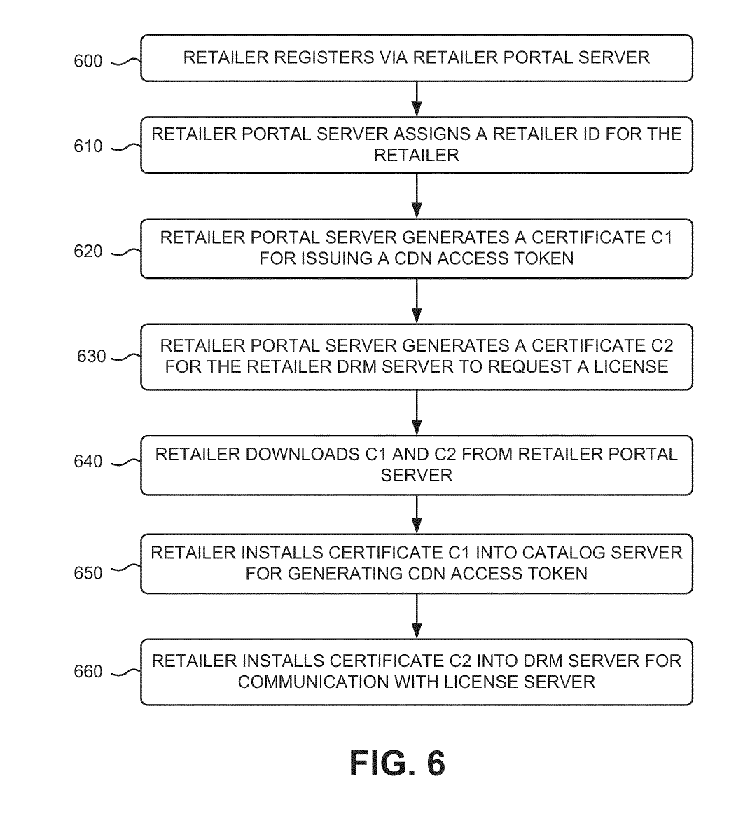

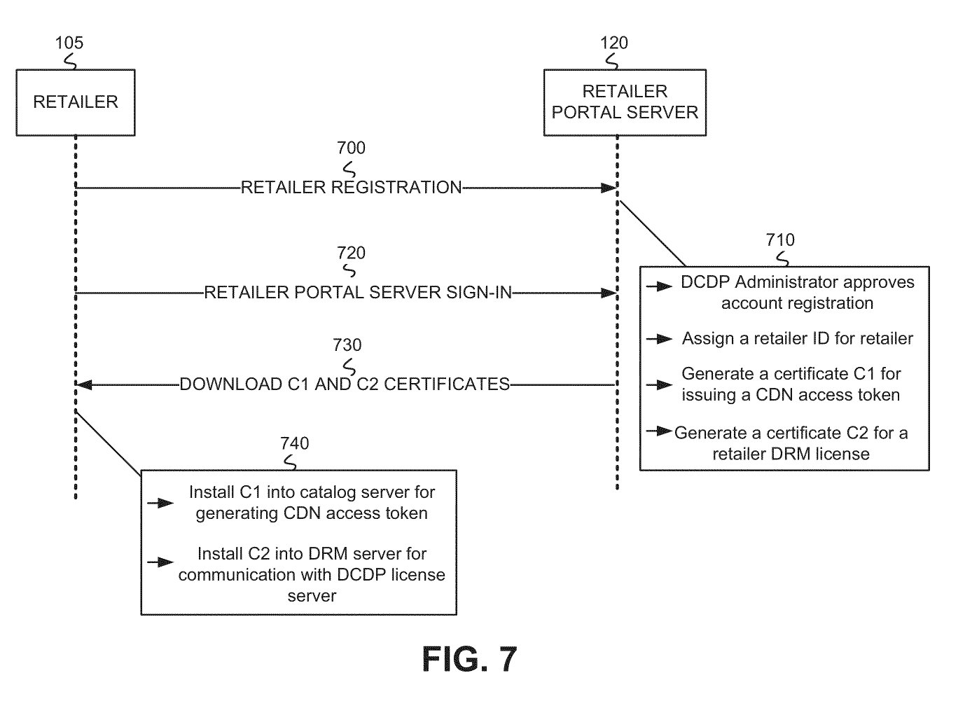

FIG. 6 is a flow diagram of an exemplary process for digital content retailer registration and retailer certificate generation to enable clients at the digital content retailer to access assets stored at DCDP 100. The exemplary process of FIG. 6 is described below as being performed at least in part by retailer 105. The portions of the process of FIG. 6 performed by retailer 105 may be performed by one or more of servers 140. In some implementations, the portions of the process of FIG. 6 performed by retailer 105 may be performed by account manager 325, device manager 330 and/or DRM server 310. The description of the exemplary process of FIG. 6 below refers to the exemplary messaging diagram of FIG. 7.

The exemplary process may include retailer 105 registering via retailer portal server 120 (block 600). An administrator of retailer 105 may, via account manager 325, device manager 330 and/or DRM server 310 access retailer portal server(s) 120 via networks 340 and 125 to register with DCDP 100. Registering may include providing retailer contact information (retailer name, email address, phone number, mailing address, etc.) and log-in credentials (e.g., log-in name, password). FIG. 7 depicts retailer 105 sending a retailer registration message 700 to retailer portal server 120.

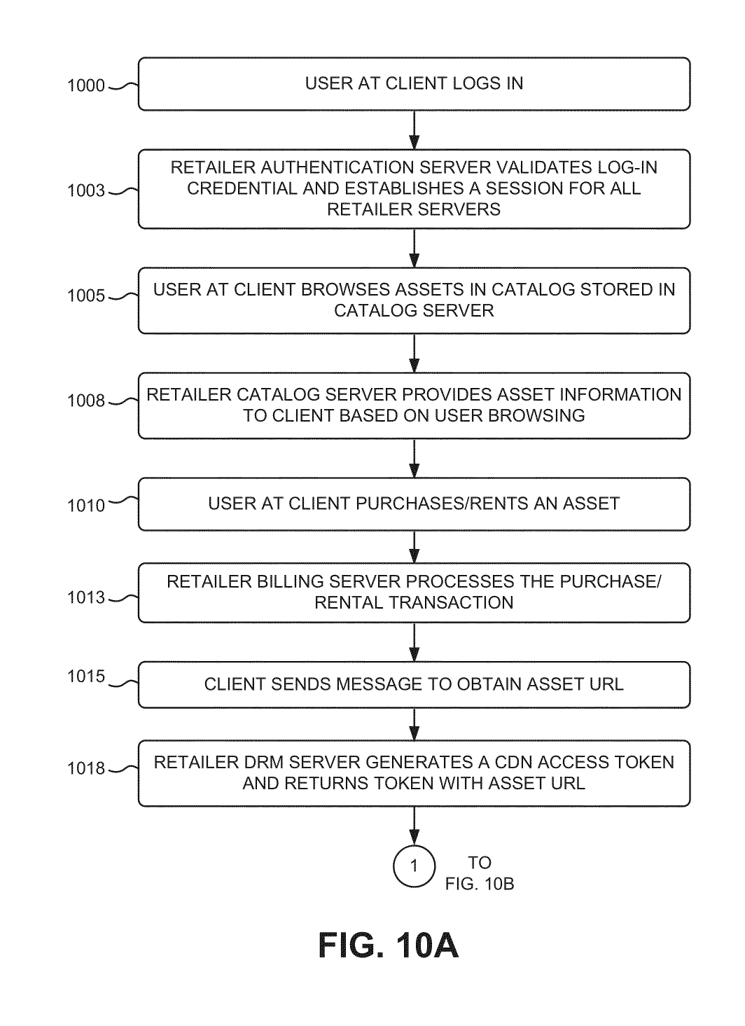

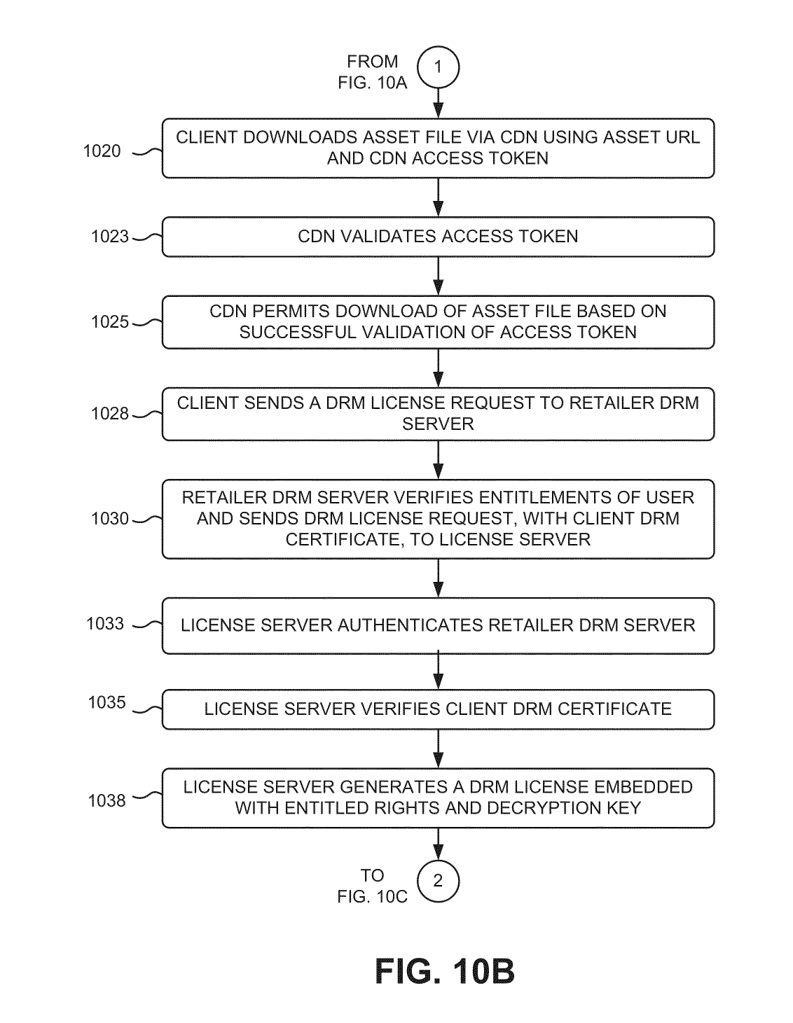

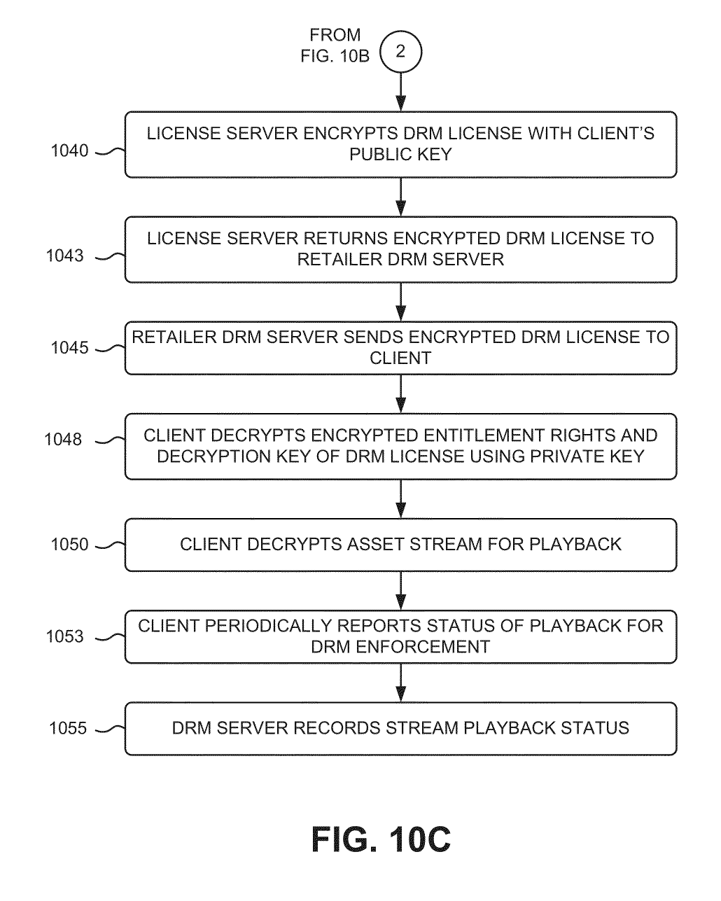

Retailer portal server 120 assigns a retailer ID for retailer 105 (block 610). Upon receipt of the retailer registration, an administrator of DCDP 100 approves or disapproves an account for the retailer. If approved, retailer portal server 120 assigns a unique retailer ID to retailer 105. FIG. 7 depicts retailer portal server 120 assigning 710 a retailer ID for retailer 105. Retailer portal server 120 generates a certificate C1 to be used the issuance of a CDN access token (block 620). The certificate C1 may include a digital certificate generated using existing techniques. FIG. 7 depicts retailer portal server 120 generating 710 certificate C1. Certificate C1 may subsequently be used by catalog server 315 (see the exemplary process of FIGS. 10A-10C below) for generating a CDN access token for retailer 105.

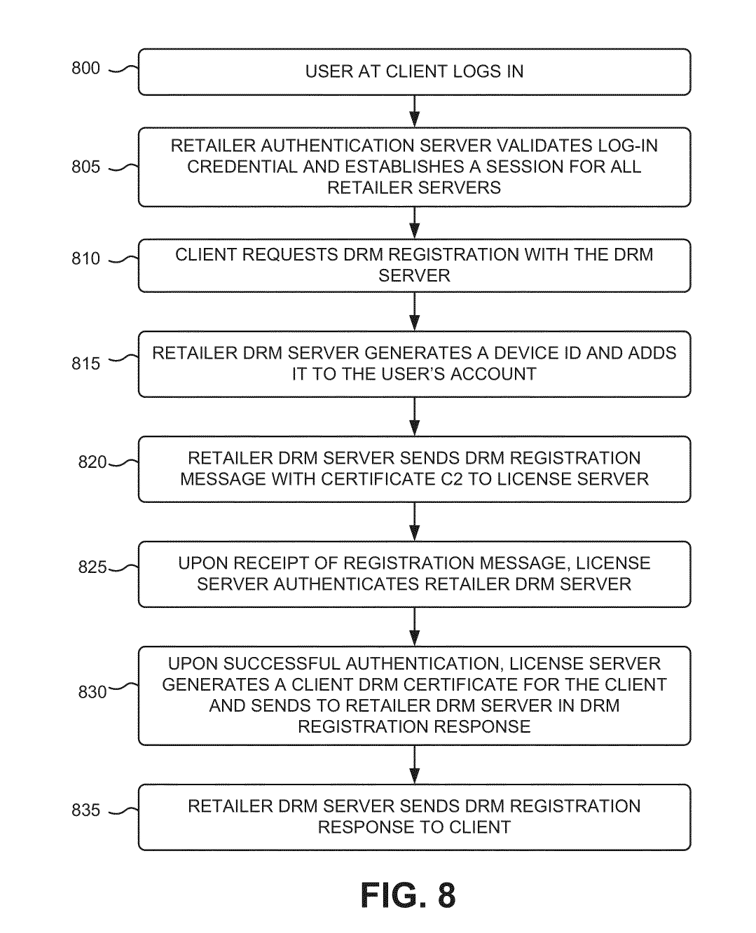

Retailer portal server 120 generates a certificate C2 for the retailer DRM server 310 to be used for requesting a license (block 630). The certificate C2 may include a digital certificate generated using existing techniques that may be the same, or different, than the techniques used to generate certificate C1. The digital certificate of C2 includes a unique digital certificate that can be used to verify the authenticity of retailer 105. FIG. 7 depicts retailer portal server 120 generating 710 certificate C2 for use in requesting a retailer DRM license. Certificate C2 may subsequently be used by DRM server 310 (see the exemplary process of FIG. 8 below) for requesting a license certificate from license server(s) 130 on behalf of a client 300 of retailer 105.

Retailer 105 downloads certificates C1 and C2 from retailer portal server 120 (block 640). Retailer 105, via network 340 and network 125, accesses retailer portal server 120 to download certificates C1 and C2 generated by retailer portal server 120 in blocks 620 and 630. FIG. 7 depicts retailer 105 downloading 730 certificates C1 and C2 from retailer portal server 120. Retailer 105 installs certificate C1 into catalog server 315 for generating a CDN access token (block 650). Catalog server 315 may subsequently issue certificate C1 to a client 300 of retailer 105 when client 300 obtains catalog metadata about a specific asset stored at DCDP 100. FIG. 7 depicts retailer 105 installing 740 certificate C1 into the catalog server for the eventual generation of a CDN access token (as described in the exemplary process of FIGS. 10A-10C below). Retailer 105 installs certificate C2 into DRM server 310 for communication with license server 130 (block 660). FIG. 7 depicts retailer 105 installing 740 certificate C2 into the DRM server for subsequent authentication by license server(s) 130.

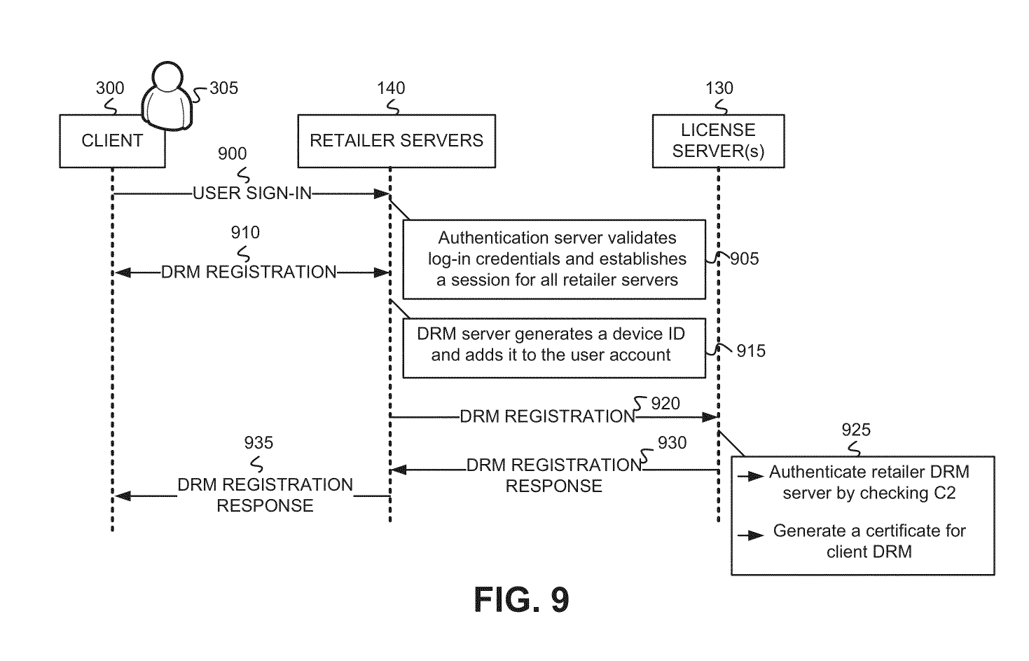

FIG. 8 is a flow diagram of an exemplary process for DRM registration of a client 300 of a retailer 105. The description of the exemplary process of FIG. 8 below refers to the exemplary messaging diagram of FIG. 9.

The exemplary process may include a user 305 at client 300 logging in (block 800). As shown in FIG. 9, user 305 may, via client 300, send a user sign-in 900 to retailer servers 140. The sign-in may include log-in credentials, such as, for example, a user name and password. Authentication server 320 of retailer servers 140 may receive the user log-in. Retailer authentication server 320 validates the log-in credentials and establishes a session for all retailer servers 140 (block 805). Retailer authentication server 320 may compare the supplied user log-in credentials with stored log-in credentials of user 305 to validate the log-in credentials. FIG. 9 depicts the authentication server of retailer servers 140 validating 905 the log-in credentials and establishing a session for retailer servers 140.

Client 300 requests DRM registration with DRM server 310 (block 810). Client 300 engages in DRM registration with DRM server 310 for the purpose of obtaining a client DRM certificate that enables client 300 to obtain a DRM license for an asset at DCDP 100 from license server(s) 130. FIG. 9 depicts client 300 engaging in DRM registration 910 with retailer servers 140. DRM registration 910 may include client 300 transmitting a DRM registration request to DRM server 310. Retailer DRM server 310 generates a device ID and adds it to the user's account (block 815). In response to receiving the DRM registration request from client 300, DRM server 310 generates a device ID that uniquely identifies client 300 among all clients 135 that have accounts with retailer 105. FIG. 9 depicts DRM server 310 generating 915 a device ID and adding it to the user's account.

Retailer DRM server 310 sends a DRM registration message with certificate C2 to license server 130 (block 820). DRM server 310, in response to the DRM registration request from client 300, sends the DRM registration message to license server(s) 130 to obtain a client DRM certificate from license server(s) 130 for client 300. FIG. 9 depicts retailer servers 140 (e.g., DRM server 310) sending a DRM registration message 920. DRM registration message 930 includes certificate C2 previously provided to retailer 105, and installed at DRM server 310 at block 660 of FIG. 6.

Upon receipt of the DRM registration message, license server 130 authenticates retailer DRM server 310 (block 825). License server(s) 130 may authenticate DRM server 310 based on certificate C2 using existing techniques. License server(s) 130 may, for example, check certificate C2 to authenticate DRM server 310 during Transport Layer Security (TSL) handshaking with DRM server 310. FIG. 9 depicts license server(s) 130 authenticating 925 retailer DRM server 310 by checking certificate C2.

Upon successful authentication, license server 130 generates a client DRM certificate for client 300 and sends the certificate to retailer DRM server 310 in a DRM registration response (block 830). License server(s) 130 may generate the client DRM certificate using existing techniques. FIG. 9 depicts license server(s) 130 generating 925 the DRM certificate for requesting client 300, and returning the DRM certificate to retailer servers 140 (e.g., DRM server 310) in a DRM registration response message 930. DRM server 310 relays the response to client 300. Retailer DRM server 310 sends a DRM registration response to client 300 (block 835). As shown in FIG. 9, upon receipt of DRM registration response message 930, retailer servers 140 (e.g., DRM server 310) sends a DRM registration response message 935 that notifies client 300 of successful completion of DRM registration. DRM server 310, on behalf of client 300 and using the stored client DRM certificate, may request a DRM license for decrypting an asset obtained from DCDP 100 (as described in blocks 1028-1050 of FIGS. 10B and 10C below).

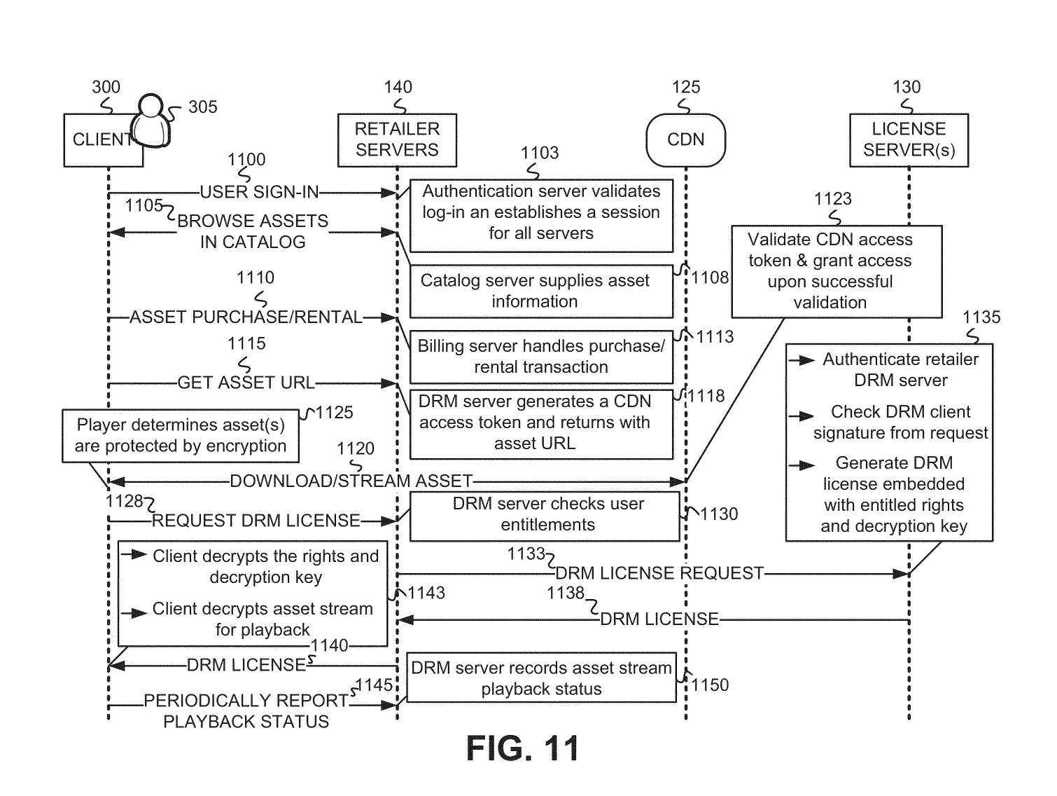

FIGS. 10A-10C are flow diagrams of an exemplary process for DRM license acquisition, and asset streaming/download to clients 135 of retailer 105. The description of the exemplary process of FIG. 10A-10C below refers to the exemplary messaging diagram of FIG. 11.

Referring to FIG. 10A, the exemplary process may include user 305 at client 300 logging in (block 1000). As shown in FIG. 11, user 305 at client 300 may send a user sign-in 1100 to retailer servers 140 (e.g., authentication server 320). The sign-in may include log-in credentials, such as, for example, a user name and password of user 305. Authentication server 320 of retailer servers 140 may receive the user log-in. Retailer authentication server 320 validates the user log-in credential and establishes a session for all retailer servers 140 (block 1003). Retailer authentication server 320 may compare the supplied user log-in credentials with stored log-in credentials of user 305 to validate the log-in credentials. FIG. 11 depicts authentication server 320 of retailer servers 140 validating 1103 the log-in credentials.

User 305 at client 300 browses assets in a catalog stored in retailer catalog server 315 (block 1005). User 305 at client 300 may, for example, use a web browser to access and browse a catalog of assets stored in retailer catalog server 315. FIG. 11 depicts user 305 of client 300 browsing 1105 assets in the catalog stored at retailer servers 140 (e.g., catalog server 315).

Retailer catalog server 315 provides asset information to client 300 based on the user browsing (block 1008). The asset information may include, for example, a title of the asset, a description of the content of the asset, and/or a length (in minutes) of the content of the asset. The asset information may include other information not described here. FIG. 11 depicts the catalog server of retailer servers 140 supplying asset information to user 305 at client 300 browsing the assets in the catalog. User 305 at client 300 rents or purchases an asset (block 1010). Based on the asset browsing, and review of the asset information supplied by the catalog server of retailer servers 140, user 305 at client 300 may choose to rent or purchase an asset from the catalog stored at catalog server 315. FIG. 11 depicts user 305 at client 300 sending a message 1110 to purchase/rent an asset from assets contained in a catalog stored at catalog server 315 of retailer servers 140. Retailer billing server 335 processes the rental or purchase transaction (block 1013). Billing server 335 receives the purchase/rental message from client 300, and processes the transaction. Billing server 335 may, for example, add a charge to user 305's account, or may charge a credit card associated with user 305's account. FIG. 11 depicts the billing server of retailer servers 140 handling 1113 the purchase/rental transaction.

Client 300 sends a message to obtain an asset Uniform Resource Locator (URL) associated with the rented or purchased asset (block 1015). Upon purchase/rental of an asset stored at DCDP 100, client 300 needs to request a URL associated with the asset to retrieve that asset from DCDP 100. FIG. 11 depicts client 300 sending a “get asset URL” message 1115 to retailer servers 140 to obtain a URL associated with the purchased/rented asset. Retailer DRM server 310 generates a CDN access token and returns the token with the asset URL (block 1018). Upon receipt of the message from client 300 requesting the asset URL associated with the rented or purchased asset, retailer DRM server 310 generates a CDN access token using existing techniques and returns a message to client 300 that includes the CDN access token and the asset URL. The CDN access token may be used by client 300 to access CDN 125 to obtain the purchased/rented asset from the asset URL. FIG. 11 depicts the DRM server of retailer servers 140 generating 1118 a CDN access token and returning the access token with the asset URL to client 300 via a message (not shown). Referring to FIG. 10B, client 300 downloads an asset, or receives the streaming asset, via CDN using the asset URL and CDN access token (block 1020). As shown in FIG. 11, client 300 attempts to download/stream 1120 the asset using the asset URL and the CDN access token. CDN 125 validates the access token (block 1023) and permits downloading/stream of the asset based on successful validation of the CDN access token (block 1025). As shown in FIG. 11, CDN 125 verifies the validity 1123 of the CDN access token received from client 300, and grants access to CDN 125 upon successful validation, allowing the downloading or streaming of the asset from DCDP 100 via CDN 125. If CDN 125 fails to verify the validity of the CDN access token received from client 300, CDN 125 may deny access to CDN 125 (not shown in FIG. 11).

Client 300 sends a DRM license request to retailer DRM server 310 (block 1028). As shown in FIG. 11, when a content player at client 300 determines that the asset downloaded/streamed from DCDP 100 via CDN 125 is protected by encryption, client 300 sends a message 1128 (signed by the client DRM certificate) requesting a DRM license from DRM server 310 of retailer servers 140. Retailer DRM server 310 verifies entitlements of user 305 and sends a DRM license request to license server 130 (block 1030). DRM server 310 may check account information associated with user 305 (e.g., stored at account manager 325) to check the entitlements of user 305. FIG. 11 depicts the DRM server of retailer servers 140 checking 1130 the user entitlements prior to requesting a license from license server(s) 130 by sending a DRM license request message 1133 (signed by the client DRM certificate) to license server(s) 130.

License server 130 authenticates retailer DRM server 310 (block 1033), verifies the client DRM certificate (block 1035), and generates a DRM license embedded with entitled rights and a decryption key (block 1038). As shown in FIG. 11, upon receipt of the DRM license request from DRM server 310 of retailers servers 140, license server(s) 130 authenticates 1135 retailer DRM server 310 from which the license request was received, checks the DRM client signature from the license request, and generates a DRM license that is embedded with entitled rights and a decryption key. Referring to FIG. 10C, license server 130 encrypts the DRM license with client 300's public key (block 1040) and returns the encrypted DRM license to retailer DRM server 310 (block 1043). FIG. 11 depicts license server(s) 130 returning a message 1138 that includes the encrypted DRM license. Retailer DRM server 310 receives the DRM license from license server(s) 130 and, in turn, sends the encrypted DRM license to client 300 (block 1045). FIG. 11 depicts DRM server of retailer servers 140 sending a message 1140 that includes the DRM license received from license server(s) 130.

Client 300 decrypts the encrypted entitlement rights and decryption key of the DRM license using its private key (block 1048) and decrypts the asset stream for playback (block 1050). FIG. 11 depicts client 300, upon receipt of message 1140 including the DRM license, decrypting 1143 the entitlement rights and decryption key of the DRM license, and then decrypting the asset stream for playback using the decryption key from the DRM license.

Client 300 periodically reports status of playback to DRM server 310 for DRM enforcement (block 1053), and DRM server 310 records the stream playback status (block 1055). FIG. 11 depicts client 300 sending a message(s) 1145 to periodically report a playback status of the asset stream, and the DRM server of retailer servers 140 recording 1150 the asset stream playback status.

As described herein, a digital content distribution platform provides digital content processing, digital content delivery, and digital rights management to customers of multiple different digital content retailers. By subscribing to the digital content distribution services offered by the digital content distribution platform, and by interaction between servers associated with the digital content retailers interact and the digital content distribution platform, the customers of the retailers are authorized to receive customer-selected digital content delivered from the digital content delivery platform to client devices of the customers.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 6, 8, and 10A-10C, the order of the blocks may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, at a digital content distribution platform, registrations from one or more digital content retailers, wherein multiple clients have accounts with each of the one or more digital content retailers;
issuing at least one digital certificate to each of the one or more digital content retailers based on receipt of the registrations; and
providing, from the digital content distribution platform, digital content processing and digital rights management (DRM), for delivering digital content to the multiple clients having accounts with the one or more digital content retailers based on the issued at least one digital certificate.

2. The method of claim 1, further comprising:
encoding, at the digital content distribution platform, the digital content;
encrypting, at the digital content distribution platform, the digital content;
storing, at the digital content distribution platform, the encrypted digital content and associated metadata;
publishing the metadata associated with the digital content from the digital content distribution platform to catalog servers associated with each of the one or more digital content retailers.

3. The method of claim 1, further comprising:
encoding, at the digital content distribution platform, the digital content in multiple different bit rates;
encoding, at the digital content distribution platform, the digital content in multiple different resolutions;
storing, at the digital content distribution platform, the encoded digital content along with associated metadata; and
publishing the metadata associated with the encoded digital content from the digital content distribution platform to catalog servers associated with each of the one or more digital content retailers.

4. The method of claim 1, wherein each of the one or more digital content retailers includes a DRM server that engages in digital rights management with a license server of the digital content distribution platform, and includes a catalog server that stores metadata associated with the digital content stored at the digital content distribution platform.

5. The method of claim 1, wherein issuing the at least one digital certificate to each of the one or more digital content retailers comprises:
issuing a first digital certificate to each of the one or more digital content retailers, wherein the first digital certificate is used for access to a content delivery network; and
issuing a second digital certificate to each of the one or more digital content retailers, wherein the second digital certificate is used for requesting a DRM license from a license server.

6. The method of claim 5, wherein each of the one or more digital content retailers installs the first digital certificate into a respective catalog server for generation of an access token for accessing the content delivery network.

7. The method of claim 6, wherein each of the one or more digital content retailers installs the second digital certificate into a respective retailer DRM server for requesting the DRM license from the license server.

8. A method, comprising:
receiving a certificate from a digital content distribution platform at a digital rights management (DRM) server associated with a first digital content retailer;
receiving a DRM registration request from a client at the DRM server, wherein the client is associated with a customer of the first digital content retailer;
sending a DRM registration request that includes the certificate from the DRM server to the digital content distribution platform;
receiving, at the DRM server, a client DRM certificate from the digital content distribution platform; and
sending, from the DRM server to the client, a DRM registration response that includes the client DRM certificate, wherein the client DRM certificate is usable by the client for requesting a DRM license for digital content stored at the digital content distribution platform.

9. The method of claim 8, wherein the customer of the first digital content retailer has a subscription account with the first digital content retailer that enables the customer to request selected items of the digital content from the digital content distribution platform.

10. The method of claim 8, further comprising:
receiving a second certificate from the digital content distribution platform at a second DRM server associated with a second digital content retailer;
receiving a DRM registration request from a second client at the second DRM server, wherein the second client is associated with a customer of the second digital content retailer;
sending a DRM registration request that includes the second certificate to the digital content distribution platform;
receiving, at the second DRM server, a second client DRM certificate from the digital content distribution platform; and
sending, from the second DRM server to the second client, a second DRM registration response that includes the second client DRM certificate, wherein the second client DRM certificate is usable by the second client for requesting a DRM license for digital content stored at the digital content distribution platform.

11. The method of claim 10, wherein the customer of the second digital content retailer has a subscription account with the second digital content retailer that enables the customer to request selected items of the digital content from the digital content distribution platform.

12. A digital content distribution platform, comprising:
a content distribution device configured to:
store digital assets and associated metadata,
encode and encrypt each of the digital assets, and
publish the metadata associated with the assets to one or more catalog servers associated with multiple digital content retailers;
a portal server configured to permit registration by the multiple digital content retailers to enable access to the stored digital assets by clients associated with the multiple digital content retailers; and
one or more license servers configured to engage in digital rights management (DRM) with multiple DRM servers associated with the multiple digital content retailers.

13. The digital content distribution platform of claim 12, wherein the clients associated with the multiple digital content retailers have subscription accounts with respective ones of the multiple digital content retailers to enable the clients to access the digital assets.

14. The digital content distribution platform of claim 12, wherein each of the multiple digital content retailers maintain at least one catalog server of the one or more catalog servers and at least one DRM server of the multiple DRM servers.

15. The digital content distribution platform of claim 12, further comprising:
a content delivery network that delivers selected ones of the digital assets to requesting ones of the clients associated with the multiple digital content retailers based on implementation of DRM between the one or more license servers and the multiple DRM servers associated with the multiple digital content retailers.

16. The digital content distribution platform of claim 12, further comprising:
an encryption key server configured to supply encryption keys, including an encryption key for each of the digital assets, to the content distribution device, and
wherein the content distribution device is further configured to encrypt each of the digital assets using one of the supplied encryption keys.

17. The digital content distribution platform of claim 12, wherein, when encoding each of the digital assets, the content distribution device is configured to:
encode each of the digital assets at multiple different bit rates.

18. The digital content distribution platform of claim 12, wherein, when encoding each of the digital assets, the content distribution device is further configured to:
encode each of the digital assets in multiple different resolutions.

19. The digital content distribution platform of claim 12, wherein, when permitting registration by the multiple digital content retailers, the portal server is configured to:
assign a unique retailer identifier to each of the multiple digital content retailers;
generate first digital certificates for the multiple digital content retailers for subsequent use in obtaining a content delivery network access token; and
generate second digital certificates for the multiple digital content retailers for subsequent use in obtaining a DRM license for each of the multiple digital content retailers.

20. The digital content distribution platform of claim 19, wherein the portal server is further configured to:
permit downloading of the first and second digital certificates by the multiple digital content retailers.
